(19) United States
(12) Patent Application Publication
(10) Pub. No.: US 2006/0174975 A1
(43) Pub. Date: Aug. 10, 2006

(54) Apparatus and method for the efficient production of high quality wood strands, flakes and wafers

(75) Inventors: Hui Wan, Sainte-Foy (CA); Xiangming Wang, Sainte-Foy (CA); Gilles Brunette, Sainte-Foy (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Forintek Canada Corp., Vancouver (CA)

(21) Appl. No.: 11/038,075

(22) Filed: Jan. 21, 2005

(51) Int. Cl. B27M 1/00

(52) U.S. Cl. 144/363

(57) ABSTRACT

An apparatus for cutting wood, the apparatus comprising a housing element defining a work surface and an interior, a means for delivering wood to the work surface, a plurality of incising elements arranged in the work surface to incise the wood in a direction substantially parallel to the fibre of the wood, a plurality of slicing blades arranged in the work surface to slice incised wood, and an opening in the work surface opening into the interior of the housing element.

### FIELD OF THE INVENTION

This invention relates to an improved apparatus and integrated method for the efficient production of high quality wood strands, flakes and wafers for use in oriented strand board (OSB) manufacturing.

### BACKGROUND OF THE INVENTION

Oriented strand board (OSB) is a structural panel product formed by layering wood strands in specific orientations and bonding the strands with exterior-grade resin under heat and pressure. The versatility of OSB products makes them increasingly important among wood products. Most notably, OSB products are stronger than particleboard and waferboard but cost less than plywood.

OSB manufacturing involves cutting debarked wood into strands, also known as flakes or wafers. Strand quality, in terms of uniformity of size and shape, and strand yield from debarked wood directly affect the production cost and quality of the final OSB product.

Strands are produced by stranders (also known as flakers or waferizers). Common types of stranders used in OSB manufacturing are the disk-type strander and the ring-type strander which have been described, for example, by Liska (Canadian Patent No. 1,192,474), Beer (U.S. Pat. No. 4,346,744), Farrell (U.S. Pat. No. 4,964,447) and Pallman (U.S. Pat. No. 6,554,032).

Known stranders typically have a rotary slicing device comprising a plurality of slots mounted with blades that project from the working surface of the slicing device. Debarked wood is sliced as the rotating blades move across the surface of the debarked wood in a direction substantially transverse to the longitudinal axis of the wood. The sliced wood is then directed at a high speed into the slots against strand breaking elements, such as a counterknife, reactor bar, and/or strand breaking strip. The impact of the sliced wood against the strand breaking elements tears the wood along its fibre orientation, rendering the wood into strands. Strand width can be controlled to a limited degree by varying the blade angle, the counterknife angle, and the distances between the strand breaking elements.

A problem with known stranding systems is that the impact of sliced wood against strand breaking elements creates a significant amount of undesirable wood dust, or fines. Fines typically account for 10 to 20% of debarked wood. The creation of fines is costly because it not only decreases yield and wastes raw material but also reduces resin efficiency during later steps in the manufacturing process. Reduced resin efficiency requires costly increases in the consumption of resin in order to maintain final OSB product quality.

Another problem with conventional stranding is the variation in strand morphology, a result inherent in a process that relies on impact forces to tear sliced wood into strands. Irregular structures in the wood add to the problem of obtaining uniform strands.

A further problem is the presence of “folded strands”. Wood sliced by a slicing blade is subjected to two types of stresses: compression stress on the side of the wood backing the blade and tension stress on the side of the wood facing the blade. Tension stress causes cracks to form on the side of the wood facing the blade. Folded strands result from these unbalanced stresses introduced in the slicing process as well as irregular structures in the wood itself.

Folded strands and variations in strand morphology adversely affect the quality and properties of the final OSB product. Mitigating the effects of poor quality strands in downstream processing can be costly and does not ensure desired product quality.

For the purpose of eliminating some of these disadvantages, Liska de-scribes a multi-phase stranding system involving independent processes for slicing the wood into veneer sheets, cutting the sheets against the wood fibre into strips, and cutting the resulting strips along the wood fibre into strands. Fine production is reduced by avoiding the step of impacting wood against strand breaking elements to obtain strands. However, the Liska system is cumbersome and costly and has not been widely adopted by the OSB manufacturing industry.

Modified strand breaking elements are known to reduce strand-folding but they typically increase the amount of fines produced.

A need remains for a cost effective apparatus and method for stranding wood which overcome at least some of the disadvantages of existing systems.

### SUMMARY

One aspect of the invention provides for an apparatus for cutting wood. The apparatus comprises a housing element defining a work surface and an interior, a means for delivering wood to the work surface, a plurality of incising elements arranged in the work surface to incise the wood in a direction substantially parallel to the fibre of the wood, a plurality of slicing blades arranged in the work surface to slice the incised wood, and an opening in the work surface opening into the interior of the housing element.

In some embodiments of the apparatus the housing element may comprise a disk. The incising elements and slicing blades may be alternately and radially arranged in the disk. The incising element may comprise an elongated cylindrical portion and a plurality of blade units circumferentially spaced and fixed lengthwise on the elongated cylindrical portion. The incising element may be partially disposed in an elongated well in the work surface, the elongated well having a length greater than the elongated cylindrical portion, the elongated cylindrical portion being freely rotatable about a longitudinal axis and the blade units, when pointing directly out of the elongated well, protruding a predetermined distance beyond a plane defined by the work surface of the disk. The blade units may be fixed apart at an equal distance, the distance corresponding to a predetermined width of the sliced and incised wood.

The slicing blade has a rake angle from 40 to 80 degrees but preferably between 55 and 65 degrees. The slicing blade has a sharpness angle from 10 to 50 degrees but preferably between 22 and 32 degrees. The slicing blade has a microbevel angle from 0 to 20 degrees but preferably between 0 and 10 degrees.

In another embodiment of the invention, the housing element of the apparatus may comprise a ring. Further embodiments of the invention may comprise a scoring knife disposed in the working surface.

A further aspect of the invention provides for a method for cutting wood. The method comprises rotating a housing element having a work surface disposed with incising elements and slicing blades, delivering wood against the work surface, incising the wood facing the work surface in a direction substantially parallel to the fibre of the wood, and slicing the incised wood in a direction substantially transverse to the fibre of the wood.

The step of incising the wood may comprise the following steps: rotating the housing element to create a movement of the incising element across the wood, wherein the incising element comprises an elongated cylinder portion with circumferentially spaced blade units fixed lengthwise on the surface of the cylinder, and wherein the incising element is partially disposed in an elongated well such that the elongated cylindrical portion is freely rotatable about a longitudinal axis and the blade units cut beyond a plane defined by the work surface of the disk into the wood by a predetermined distance; translating the movement of the incising element across the wood into a rotation of the elongated cylinder portion through the cutting contact between the wood and the blade units; and allowing the resulting rotation of the elongated cylinder portion to cause successive blade units to cut into the wood until the incising element passes completely across the wood.

The step of incising the wood may further comprise predetermining the distance between the blade units of the incising element to determine the width of the sliced and incised wood.

The method further comprises a slicing step wherein a slicing blade slices the incised wood.

The method may further comprise a scoring step preceding the incising step wherein the wood is scored in one or more lengths running substantially transverse to the fibre of the wood.

Further aspects of the invention and features of specific embodiments of the invention are described below.

### DESCRIPTION OF THE DRAWINGS

In drawings which depict non-limiting embodiments of the invention:

FIG. 1 is a partial front view of one embodiment of the present invention;

FIG. 2 is a partial side cross-sectional view of the embodiment shown in FIG. 1;

FIG. 3 is a section taken along plane I-I in FIG. 2;

FIG. 4 shows a slicing blade of the apparatus shown in FIG. 1, enlarged; and

FIG. 5 is a partial cross-sectional view of another embodiment of the present invention.

### DETAILED DESCRIPTION

The present invention relates to an improved apparatus and integrated method for stranding wood by producing strands of uniform shape and size while reducing strand-folding and fines. Debarked wood is incised prior to slicing to ensure uniform strand width and to facilitate a modified slicing step that reduces fines and folding strands.

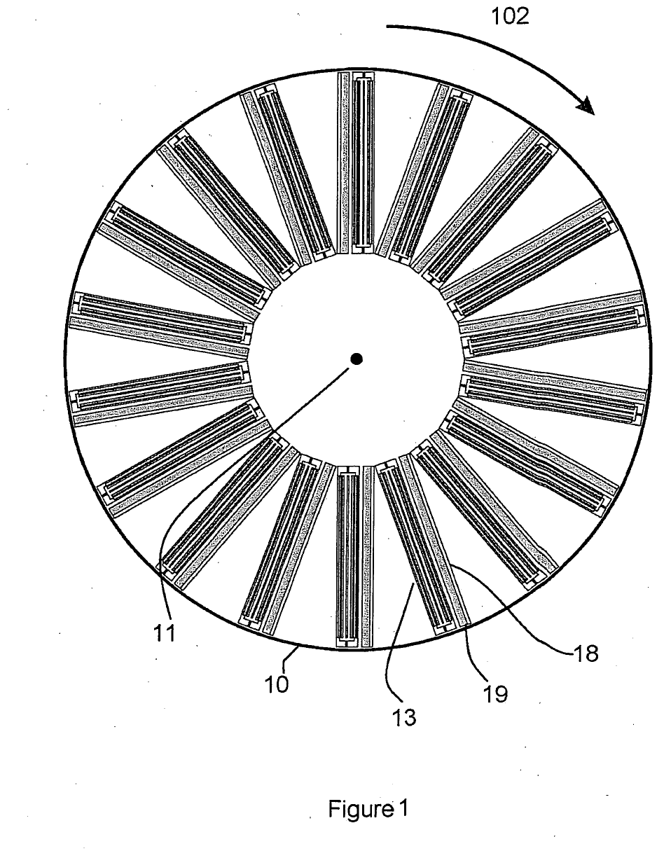

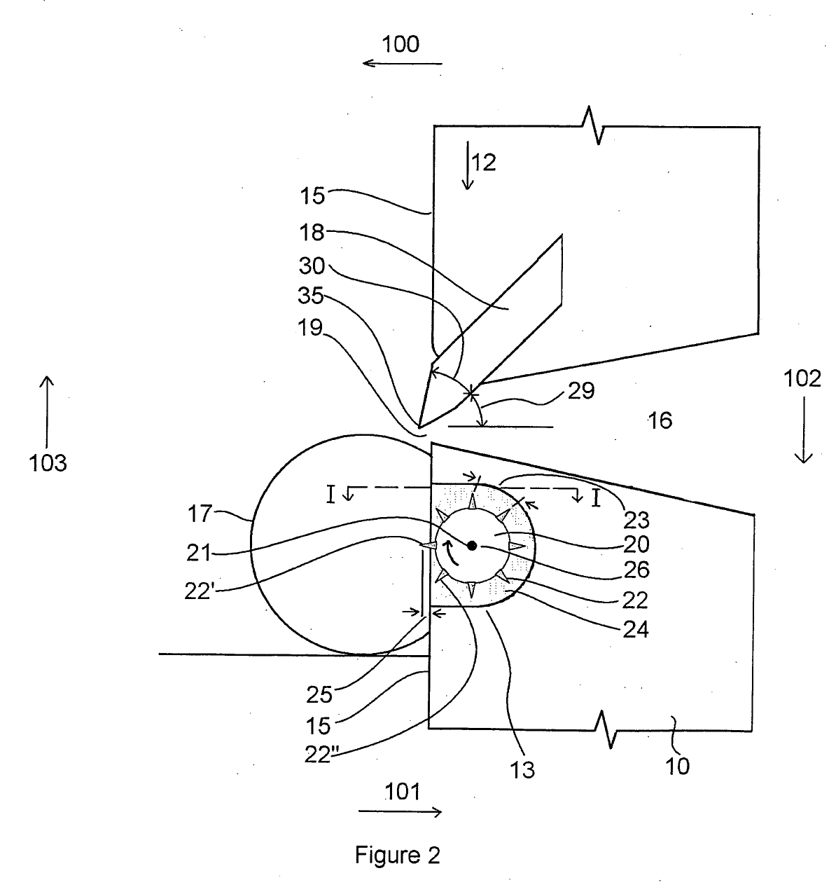

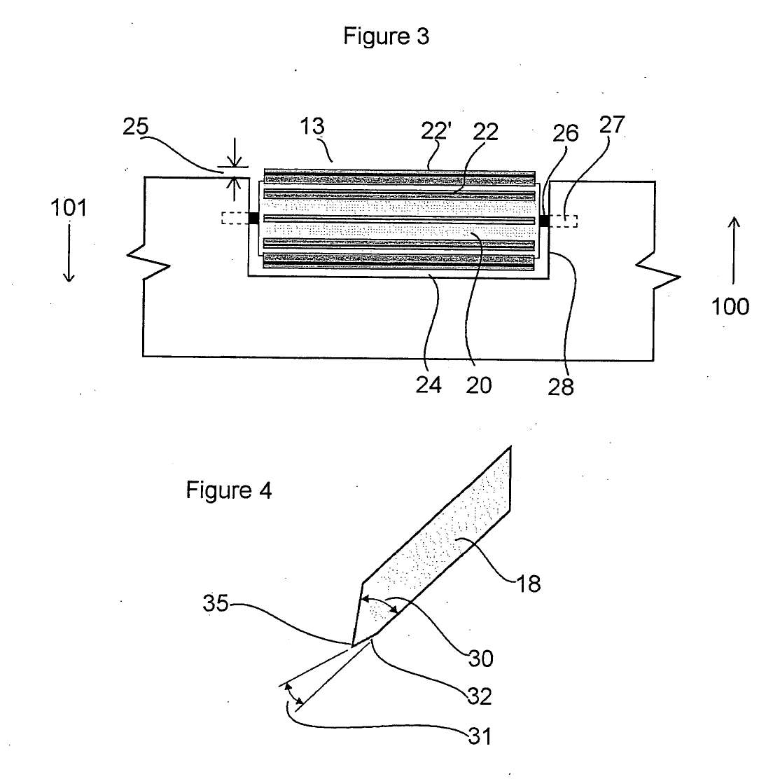

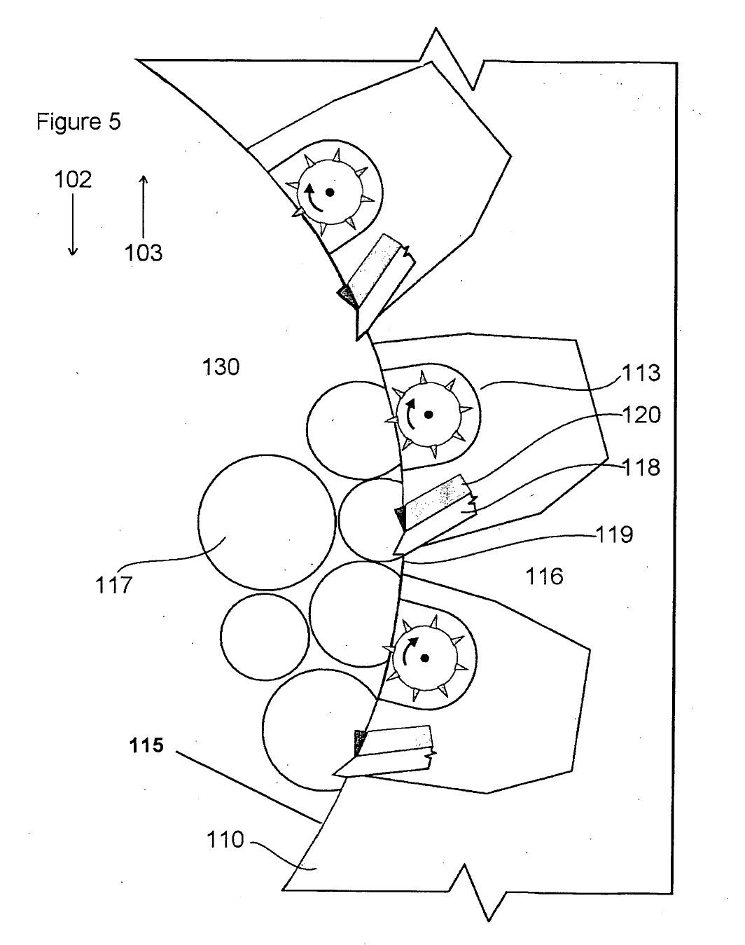

This description uses the following directional conventions to clarify its meaning:
“front”, “forward”, “forwardly”, “forwardmost” and similar words are used to refer to the direction indicated by arrow 100 (FIGS. 2 and 3);
“back”, “rear”, “rearwardly”, “rearmost” and similar words are used to refer to the direction indicated by arrow 101 (FIGS. 2 and 3);
“leading” is used to refer to the direction indicated by arrow 102 (FIGS. 1, 2 and 5); and
“trailing” is used to refer to the direction indicated by arrow 103 (FIGS. 2 and 5).

FIG. 1 shows a front view of a disk 10 of a strander according to one embodiment of the present invention. Disk 10 is rotated by motor means (not shown) about an axis of rotation 11 in leading direction 102. A plurality of incising elements 13 and slicing blades 18 are radially and alternately arranged in disk 10.

A partial cross-sectional view of disk 10 is shown in FIG. 2. The front face of disk 10 comprises substantially planar work surface 15. Debarked wood 17 is directed rearwardly against work surface 15. Incising element 13 and slicing blade 18 partially project forwardly from work surface 15 to incise and slice wood 17, as explained further below.

As shown in FIG. 2 and FIG. 3 (a section taken along plane I-I in FIG. 2), incising element 13 of this embodiment of the invention comprises an elongated cylinder 20. Cylinder 20 defines an axis of rotation 21. A plurality of elongated blades 22 are circumferentially spaced and fixed lengthwise along the surface of cylinder 20. The blades 22 are not necessarily irremovably fixed, but in a preferred embodiment may be removed and replaced. As shown in FIG. 2, the side profile of blades 22 may be wedge-shaped. The length of blades 22 may be slightly less than the length of cylinder 20. FIG. 2 shows blades 22 spaced an equal distance 23 apart. Distance 23 corresponds to the desired width of strands, as explained further below. In an alternative embodiment, blades 22 may be spaced apart at two or more different distances, resulting in the production of strands with two or more different widths. Those skilled in the art will appreciate that the shape of blades 22 may be changed to control the width of the strands. The shape and size of blades 22 may also be adjusted in known manners to maximize their strength and durability. Also, there may be blades of different types and dimensions on cylinder 20, one for example for separating strands and another to punch holes on the strands to improve the permeability of the strands and to balance the structure of the strands to reduce folding.

Incising element 13 is partially disposed in an elongated well 24 in work surface 15. FIG. 3 shows incising element 13 rotatably disposed in well 24 by means of rod 26 fixed axially through the centre of cylinder 20 and fitted rotatably into holes 27 in sidewalls 28 of well 24. Bearings (not shown) may be incorporated into holes 27 to facilitate low friction rotation of rod 26. Incising element 13 is positioned in well 24 such that the entirety of cylinder 20 is rearward of the plane of work surface 15 and a blade 22′ pointing directly forward from well 24 protrudes a predetermined distance 25 forwardly beyond the plane of work surface 15. Distance 23 between blades 22 is such that at least one of blades 22 projects beyond the plane of work surface 15 at any given time. Incising element 13 is thus configured to make multiple incisions in wood 17 in a direction substantially parallel to the fibre of the wood.

Adjacent to the trailing side of well 24 along work surface 15 is rectangular slit 19. As shown in FIG. 1, the length of slit 19 runs radially along disk 10 and is positioned between incising element 13 and slicing blade 18. As shown in FIG. 2, slit 19 opens rearwardly into disk interior 16. Disk interior 16 progressively widens toward the rear of disk 10. At the rear of disk 10 are means for collecting the strands produced and/or directing the strands to the next stage of manufacturing (not shown).

Slicing blade 18 projects from the trailing side of slit 19. Slicing blade 18 is configured to slice wood incised by element 13 into strands and direct the strands toward slit 19 and into disk interior 16. As shown in FIG. 2, most of slicing blade 18 is disposed in disk 10. Slicing blade 18 comprises blade tip 35 which projects from the plane of work surface 15 in a leading direction. In particular, slicing blade 18 is fixed at a rake angle 29 ranging from 40 to 80 degrees but preferably between 55 and 65 degrees. Rake angle 29 is defined by the acute angle formed between the side of slicing blade 18 facing disk interior 16 and a plane perpendicular to work surface 15.

As shown in FIG. 4, slicing blade 18 has a knife sharpness angle 30 ranging from 10 to 50 degrees but preferably between 22 and 32 degrees. With reference to FIG. 2, knife sharpness angle 30 is defined by the angle formed between the side of slicing blade 18 facing disk interior 16 and the forwardmost side of slicing blade 18. FIG. 4 also shows that slicing blade 18 has a microbevel angle 31 ranging from 0 to 20 degrees but preferably between 0 and 10 degrees, wherein the microbevel angle is the acute angle formed by the plane of the microbevel 32 and the side of slicing blade 18 facing the disk interior 16.

Setting rake angle 29, knife sharpness angle 30 and microbevel angle 31 in the ranges described, either individually or in combination, decreases the tension stress in the wood being sliced. Reduced tension stress in the sliced wood in turn decreases the tendency of the strand to crack and to fold, thereby reducing the occurrence of folded strands. The disclosed combination of angles also reduces slicing blade wear.

A scoring knife (not shown) may be disposed in working surface 15 adjacent to the leading side of incising element 13. The scoring knife may be of a type known in the art. The scoring knife may comprise one or more blades which project from the working surface 15 and score the surface of wood 17 against working surface 15 along or more lengths in a direction substantially transverse to the fibre of the wood.

The strander according to the embodiment of the invention shown in FIGS. 1 to 4 operates in the following manner.

Incising elements 13 and slicing blades 18 rotate together about axis of rotation 11 when the strander is in operation. Feeding means (not shown) deliver debarked wood 17 in a rearward direction against work surface 15 such that the fibre of wood 17 is aligned substantially transverse to the direction of rotation 12. The rotation of disk 10 causes incising elements 13 and slicing blades 18 to make multiple passes across the surface of wood 17 facing work surface 15 until wood 17 is completely stranded.

More particularly, as an incising element 13 passes across the surface of wood 17, one or more blades 22 protruding from the plane of the work surface 15 “catch” and incise the surface of wood 17 in a direction substantially parallel to the fibre of the wood. In FIG. 2, blade 22′ is shown incising wood 17. The depth of the incision, from the surface of wood 17, is substantially equal to predetermined distance 25, that is, the amount of projection of blade 22′ from the plane of work surface 15. Distance 25 may be set such that the depth of the incisions is less than, equal to, or greater than the desired thickness of the strand. The contact between the surface of wood 17 and blade 22′ translates the relative movement between the surface of wood 17 and incising element 13 into a rotary movement of freely rotatable cylinder 20. As cylinder 20 rotates, the next blade, blade 22″, incises the surface of wood 17 at a distance 23 apart from the previous incision made by blade 22″. In this way, successive blades 22 cut into the surface of wood 17 until incising element 13 and wood 17 pass completely across one another. The surface of wood 17 facing work surface 15 now has several incisions spaced a distance 23 apart running in a direction substantially parallel to the fibre of the wood.

Incised wood 17 is then sliced by slicing blade 18 in a direction substantially transverse to the fibre of wood 17. Strands are thus immediately formed upon slicing due to the incisions in the surface of wood 17. The momentum created by the relative movement between wood 17 and slicing blade 18, as well as the relative configuration of slicing blade 18 and slit 19 (see FIG. 2), causes the newly formed strands to be directed through slit 19 into disk interior 16. The strands are then collected or directed to the next stage of processing (not shown).

The above process of incising and slicing wood 17 is repeated with successive sets of incising elements 13 and slicing blades 18 as disk 10 rotates until wood 17 is completely stranded.

By incising wood prior to slicing according this invention, strands are produced immediately upon slicing. Producing strands at the slicing step obviates the need for strand breaking elements to break up sliced wood into strands, and thereby reduces the amount of fines produced. Incising the wood accordingly also allows strand width to be predetermined. Incising also mitigates problems associated with irregularities in the wood, thereby increasing the yield of uniformly shaped strands. Incising at different depths also balances the strand structure and thereby reduces folding, and improves the permeability of strands. Further, the addition of a scoring knife (not shown) as described above will permit the length of the strands to be predetermined as well.

Those skilled in the art will appreciate that the invention is not limited to application in disk-type stranders. For example, the invention is also applicable to ring-type stranders as illustrated in FIG. 5.

FIG. 5 is a partial cross-sectional view of an alternative embodiment of the invention. A plurality of incising elements 1 13 and slicing blades 118 are disposed along tubular inner working surface 115 of a ring 110 (partly shown). Each slicing blade 118 is fixed on the trailing side of a slit 119 opening into ring interior 116. Scoring knife 120 may be disposed between each incising element 113 and slicing blade 118. In the embodiment shown, each scoring knife 120 is fixed in ring 110 immediately on the trailing side of each slicing blade 118. The features and functions of incising elements 113, slicing blades 118 and scoring knife 120 are analogous to those described for incising elements 13, slicing blades 18 and scoring knife 20 in the previously described embodiment, respectively, and will not be discussed further herein.

In operation, wood 117 in tubular cavity 130 is directed against working surface 115 of ring 110 by feeding means (not shown). Ring 110 is rotated in the leading direction about an axis (not shown) of tubular cavity 130. The surface of wood 117 against working surface 115 is scored by scoring knife 120 in a direction transverse to the fibre of the wood. Next, incising element 113 cuts multiple parallel incisions in wood 117 in a direction substantially parallel to the fibre of the wood, in the manner described above for the previous embodiment. Slicing blade 118 then slices wood 117 into strands and directs the strands into ring interior 116 through slit 119. The process is repeated by successive sets of scoring knives 120, incising elements 113 and slicing blades 118 until wood 117 is completely stranded. As shown in FIG. 5, this embodiment is capable of stranding several pieces of wood 17 at the same time.

As will be apparent to those skilled in the art in the light of the foregoing disclosure, many alterations and modifications are possible in the practice of this invention without departing from the spirit or scope thereof. For example:
incising elements 13 and 113 may be removably disposed in disk 10 or ring 110, respectively, in order to permit quick repairs or replacement with a minimum of “down time” of the strander;
incising elements 13 and 113 may comprise alternative cutting means. For instance, the incising blades may be disposed on caterpillar treads with rollers instead of a cylinder. Or, the incising element may comprise completely different cutting means such as a piston-action blade that rapidly projects from and retracts into disk 10 or ring 110; and

Accordingly, the scope of the invention is to be construed in accordance with the substance defined by the following claims.

We claim:

1. An apparatus for cutting wood, the apparatus comprising:
a housing element defining a work surface and an interior;
a means for delivering wood to the work surface;
a plurality of incising elements arranged in the work surface to incise the wood in a direction substantially parallel to the fibre of the wood;
a plurality of slicing blades arranged in the work surface to slice the incised wood; and
an opening in the work surface opening into the interior of the housing element.

2. An apparatus for cutting wood according to claim 1 wherein the incising elements and slicing blades are radially and alternately arranged in the housing element.

3. An apparatus for cutting wood according to claim 2 wherein the housing element comprises a disk.

4. An apparatus for cutting wood according to claim 2 wherein the housing element comprises a ring.

5. An apparatus for cutting wood according to claim 1 wherein the incising element comprises
an elongated cylindrical portion and
a plurality of blade units circumferentially spaced and fixed lengthwise on a surface of the elongated cylindrical portion.

6. An apparatus for cutting wood according to claim 5 wherein the incising element is partially disposed in an elongated well in the work surface, the elongated well having a length greater than the elongated cylindrical portion, the elongated cylindrical portion being freely rotatable about a longitudinal axis and the blade units, when pointing directly out of the elongated well, protruding a predetermined distance beyond a plane defined by the work surface of the disk.

7. An apparatus for cutting wood according to claim 6 wherein the blade units are fixed an equal distance apart, the distance corresponding to a predetermined width of the sliced and incised wood.

8. An apparatus for cutting wood according to claim 7 wherein the slicing blade has a rake angle from 40 to 80 degrees.

9. An apparatus for cutting wood according to claim 8 wherein the slicing blade has a rake angle between 55 and 65 degrees.

10. An apparatus for cutting wood according to claim 7 wherein the slicing blade has a sharpness angle from 10 to 50 degrees.

11. An apparatus for cutting wood according to claim 10 wherein the slicing blade has a sharpness angle between 22 and 32 degrees.

12. An apparatus for cutting wood according to claim 7 wherein the slicing blade has a microbevel angle from 0 to 20 degrees.

13. An apparatus for cutting wood according to claim 12 wherein the slicing blade has a microbevel angle between 0 and 10 degrees.

14. An apparatus for cutting wood according to claim 1 wherein the housing element further comprises a scoring knife.

15. An apparatus for cutting wood comprising means for making a plurality of incisions in the wood in a direction substantially parallel to the fibre orientation of the wood and means for slicing the incised wood to produce strands.

16. An apparatus for cutting wood according to claim 15 wherein the means for incising the wood comprises means for predetermining the width of the strands.

17. A method for cutting wood comprising:
rotating a housing element having a work surface disposed with incising elements and slicing blades;
delivering wood against the work surface;
incising the wood facing the work surface in a direction substantially parallel to the fibre of the wood; and
slicing the incised wood in a direction substantially transverse to the fibre of the wood.

18. A method for cutting wood according to claim 17 wherein incising the wood comprises:
rotating the housing element to create a movement of the incising element across the wood, wherein the incising element comprises an elongated cylinder portion with circumferentially spaced blade units fixed lengthwise, and wherein the incising element is partially disposed in an elongated well such that the elongated cylindrical portion is freely rotatable along a longitudinal axis and the blade units cut beyond a plane defined by the work surface of the disk into the wood by a predetermined distance;
translating the movement of the incising element across the wood into a rotation of the elongated cylinder portion through the cutting contact between the wood and the blade units; and
allowing the rotation of the elongated cylinder portion to cause successive blade units to cut into the wood until the incising element passes completely across the wood.

19. A method for cutting wood according to claim 18 wherein incising the wood comprises setting the distance between the blade units of the incising element to determine the width of the sliced, incised wood.

20. A method for cutting wood according to 19 wherein the slicing blade has a rake angle from 40 to 80 degrees.

21. A method for cutting wood according to claim 20 wherein the slicing blade has a rake angle between 55 and 65 degrees.

22. A method for cutting wood according to claim 19 wherein the slicing blade has a sharpness angle from 10 to 50 degrees.

23. A method for cutting wood according to claim 22 wherein the slicing blade has a sharpness angle between 22 and 32 degrees.

24. A method for cutting wood according to claim 19 wherein the slicing blade has a microbevel angle from 0 to 20 degrees.

25. A method for cutting wood according to claim 24 wherein the slicing blade has a microbevel angle between 0 and 10 degrees.

26. A method for cutting wood according to claim 17 wherein the incising step is preceded by a scoring step wherein the wood is scored in one or more lengths running transverse to the fibre of the wood.
